(19) United States
(12) Patent Application Publication
(10) Pub. No.: US 2026/0112341 A1
(43) Pub. Date: Apr. 23, 2026

(54) HEIGHT LOCKING DEVICE FOR PERCUSSION STANDS

(71) Applicant: DRUM WORKSHOP, INC., Oxnard, CA (US)

(72) Inventors: Donald G. LOMBARDI, Westlake Village, CA (US); Ruben STEINHAUSER, Altusried (DE); Richard A. SIKRA, Thousand Oaks, CA (US); Dominik LANDGRAF, Waltenhofen (DE)

(21) Appl. No.: 18/920,526

(22) Filed: Oct. 18, 2024

(51) Int. Cl. G10D 13/10

(52) U.S. Cl. CPC G10D 13/28

(57) ABSTRACT

Disclosed herein are height locking devices for percussion stands and related methods and systems. Some devices according to the present disclosure comprise a housing, a retracting (e.g., auto-retracting) spool, and a cord. The housing is configured to connect to the base of a percussion stand. Similarly, a free end of the cord is configured to attach to the drum stand's uppermost tube. When the cord is unlocked such that the automatically retracting spool is acting upon it, the upper tube(s) of the stand can be adjusted such that the stand is at its desired height, and the cord length locked into place. Upon breakdown of the stand, the cord will become slack but will not retract into the spool. Upon redeployment of the stand, the user can adjust the uppermost tube upward until the cord is pulled taut, and thus the stand will be substantially the same height as before.

### BACKGROUND

### 1. Field of the Disclosure

The present disclosure relates to percussion stands, and, more specifically, height locking devices for use with percussion stands such as drum and cymbal stands.

### 2. Description of the Related Art

Percussion instrument stands are used to hold percussion instruments at a height more accessible to the user. Some such stands are described, for example, in U.S. Pat. No. 4,889,028 to Lombardi, which is fully incorporated by reference herein in its entirety. Modern drum stands typically utilize two or more telescoping tubes, with the upper, smaller diameter tube(s) being extracted upward from the bottom, largest diameter tube to the desired height, and then locked into place using, for example, a wing nut or other similar locking device. Drummers have particular preferences for their drum stand height settings. When the stand is in use, it is set to the drummer's height preference. But, a drum stand is typically collapsed or taken apart when stored or transported, and the drummer needs to re-adjust the stand to his or her preferred height when redeploying it for use. Repeating the process can be time consuming and frustrating, and can lead to inconsistencies in drum stand height.

Current stands with a “lockable” height do not allow for consistent and efficient breakdown and redeployment at the same height. Some memory locks that can be attached to stands do exist in the art, but they are typically attached to the outside of stand tubing and add excessive bulk and weight to products that are already typically heavy. Accordingly, there is a present need for a novel, simple, efficient, cost-effective way to ensure height consistency with a drum stand.

### SUMMARY OF THE DISCLOSURE

One embodiment of a height locking device for a percussion stand according to the present disclosure includes a housing configured to be connected to the base of a percussion stand. The device further includes a retractable spool rotatably mounted inside the housing, and a cord with a spool end attached to the spool, a body at least a part of which is coiled around the spool, and a free end outside the housing. The free end is configured to be connected to the percussion stand's uppermost tube. In one embodiment, the spool is automatically retracting and the device further includes a locking mechanism configured to inhibit retraction of the cord when engaged.

One embodiment of a percussion stand system according to the present disclosure includes a percussion stand and a height locking device for a percussion stand, where the height locking device is configured to attach to the stand and where the stand is configured to accept the height locking device. The stand includes at least two tubes, and more specifically at least a lowermost tube and an uppermost tube (though it is understood that intermediate tubes are possible), and a plurality of legs.

One embodiment of a method of setting the height of a percussion stand system according to the present disclosure utilizes a percussion stand with a lowermost tube, an uppermost tube connected to the lowermost tube, and a height locking device including a retracting (e.g., auto-retracting) spool, a cord, and a locking mechanism. The height locking device is connected to the lowermost tube and a free end of the cord is connected to the uppermost tube. When the locking mechanism is disengaged such that the retracting spool is acting upon the free end of the cord such that the cord is taut, the uppermost tube is extended relative to the lowermost tube to a desired height. The locking mechanism is then engaged such that the retracting spool is no longer acting on the free end of the cord.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 is a perspective view of one embodiment of a height locking device according to the present disclosure, in a partially retracted position;

FIG. 2 is another perspective view of the height locking device of FIG. 1;

FIG. 3 is a side view of the height locking device of FIG. 1;

FIG. 4 is an opposite side view of the height locking device of FIG. 1;

FIG. 5 is a perspective view of the height locking device of FIG. 1, without the housing;

FIG. 6 is a top perspective view of the height locking device of FIG. 1 in conjunction with a prior art drum stand bottom leg connector;

FIG. 7 is a side view of the height locking device of FIG. 1 connected to a drum stand;

FIG. 8A is a cut-away view of the height locking device of FIG. 1 connected to a drum stand with the cord of the device locked to a specific length and the drum stand not set to the locked length; and

FIG. 8B is a cut-away view of the height locking device of FIG. 1 connected to a drum stand with the cord of the device locked to a specific length and the drum stand set to the locked length.

### DETAILED DESCRIPTION OF THE DISCLOSURE

Disclosed herein are height locking devices for drum stands and methods and systems related thereto. Some devices according to the present disclosure comprise a housing, a spool with the ability to retract, and a cord. One end of the cord is attached to the spool and the body of the cord is wrapped around the spool with one end of the cord remaining free. The spool and the cord, except the free end, are rotatably attached inside the housing. The free end of the cord is located outside the housing, and can be pulled to extract more of the cord and increase the external length of the cord. In some embodiments the spool can be automatically retracting, though it should be understood that manually retracting embodiments are also possible.

The height locking device can include a connection piece for connecting (e.g., removably connecting) the device to a drum stand, such as to the bottom/base of a drum stand's bottom central tube. In a preferred embodiment, the cord moves through an opening on the connection piece, and in this way passes into the drum stand tube. The free end of the cord can then be passed through the hollow tube or tubes of a drum stand and then attached to the drum stand, such as to one of the drum stand tubes (e.g., bottom of the uppermost tube or a portion (e.g. top, intermediate, bottom) of an intermediate or lower tube). This attachment can be done using, for example, a plug, or other connection means known in the art. When the drum stand is adjusted to its desired height, the cord will be taut due to the self-retracting nature of the height locking device, and the cord length can be locked using a locking mechanism that is part of the height locking device.

Typically, a drum stand is broken down by retracting one or more upper tubes of the stand into the lowermost tube having the widest diameter (for instance, the drum stand may include one bottom tube and one upper tube, three tubes including a bottom, intermediate, and upper tube, or even more tubes). Embodiments of the present invention can utilize standard and non-standard tube diameters, and even shapes. By way of example only, the lowermost tube and/or the opening at the bottom of the lowermost tube can have an inner diameter of 1 mm to 4 mm or 2 mm to 3 mm, and/or the uppermost tube can have an inner diameter of 0.5 mm to 3 mm or 1 mm to 2 mm, but it should be understood that many different diameters are possible. When this is done to a stand including the height locking device in its locked configuration, so long as the cord length is locked, the cord becomes slack, and the stand can be broken down normally. When the stand is redeployed, the upper tube(s) can be extended from the lower tube until the cord has been pulled taut, at which point the upper tube(s) can be locked into place using standard drum stand locking mechanisms such as a wing nut. The cord length will be substantially the same as prior to breakdown, and thus the overall drum stand height should also be substantially the same.

In the following detailed description, numerous specific details are set forth in order to provide a more thorough understanding of embodiments incorporating features of the present disclosure. However, it will be apparent to one skilled in the art that devices, methods, and assemblies according to the present disclosure can be practiced without necessarily being limited to these specifically recited details.

Embodiments of the disclosure are described herein with reference to illustrations that are schematic illustrations of embodiments of the disclosure. As such, the actual size, components and features can be different, and variations from the shapes of the illustrations as a result, for example, of technological capabilities, manufacturing techniques and/or tolerances are expected. Embodiments of the disclosure should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the disclosure. In addition, components may be shown as one unit but may instead be a collection of components or units, or a collection of components or units may exist as one unit.

Throughout this description, the preferred embodiment and examples illustrated should be considered as exemplars, rather than as limitations on the present disclosure. As used herein, the term “disclosure,” “device,” “assembly,” “system” “method,” “present disclosure,” “present device” or “present method” refers to any one of the embodiments of the disclosure described herein, and any equivalents. Furthermore, reference to various feature(s) of the “disclosure,” “device,” “assembly,” “system,” “method,” “present disclosure,” “present device” or “present method” throughout this document does not mean that all claimed embodiments or methods must include the referenced feature(s).

It is also understood that when an element or feature is referred to as being “on” or “adjacent” another element or feature, it can be directly on or adjacent to the other element or feature, or intervening elements or features may also be present. It is also understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Relative terms such as “outer,” “inner,” “upper,” “above,” “lower,” “below,” “horizontal,” “vertical” and similar terms may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

While the term “drum stand” is used throughout for simplicity, this term should be construed to include other types of percussion instrument stands such as, but not limited to, cymbal stands. While the term “free end” is used throughout in connection with the cord element, this phrase should be construed to include embodiments where a portion of the cord other than its literal end is pulled, connected to, or otherwise acted upon as described herein; e.g., when the present disclosure describes the free end of the cord being attached to a plug, it should be understood that there may also be a slack and/or non-operating portion of the cord after the connection to the plug.

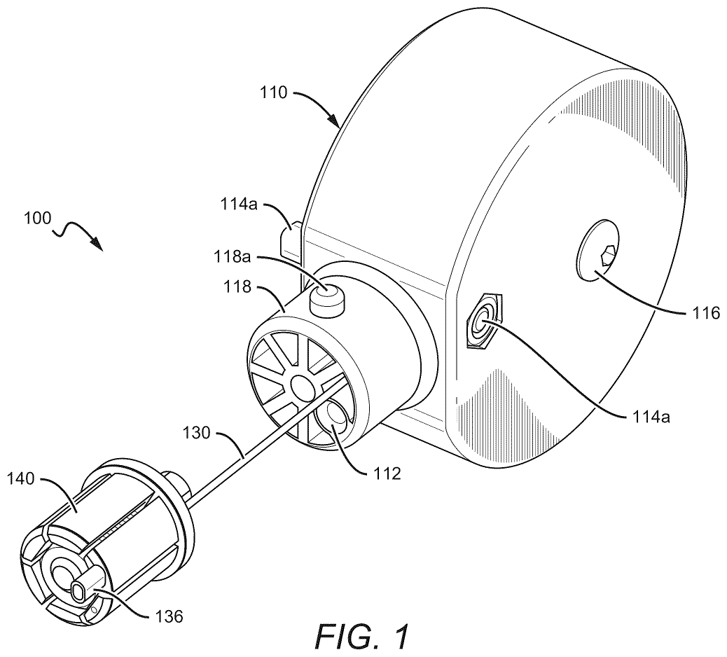

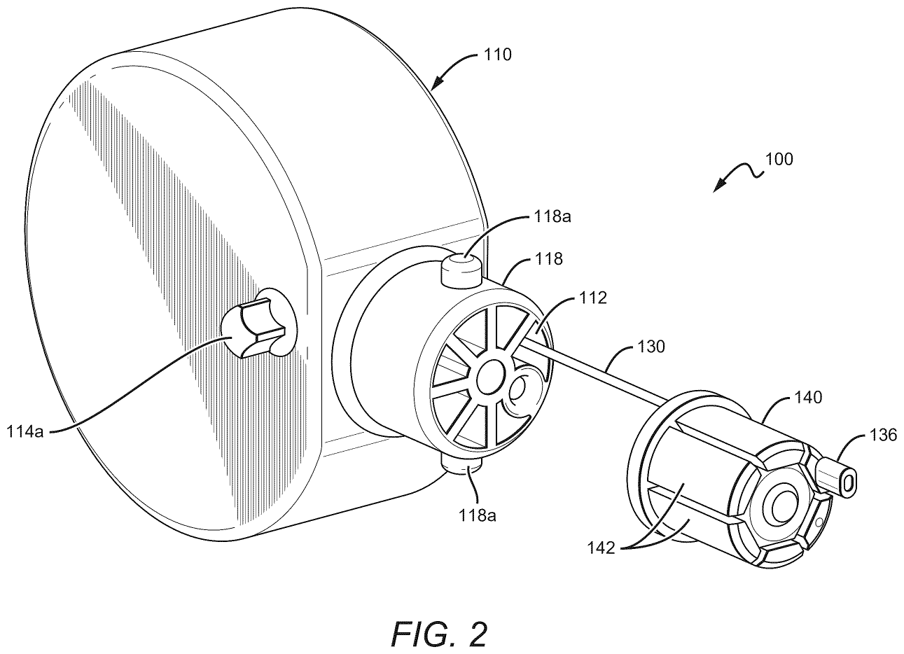

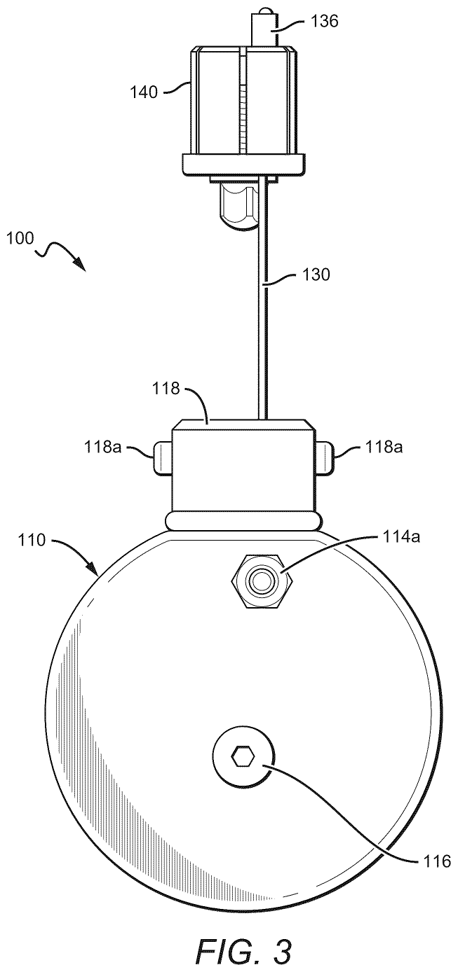

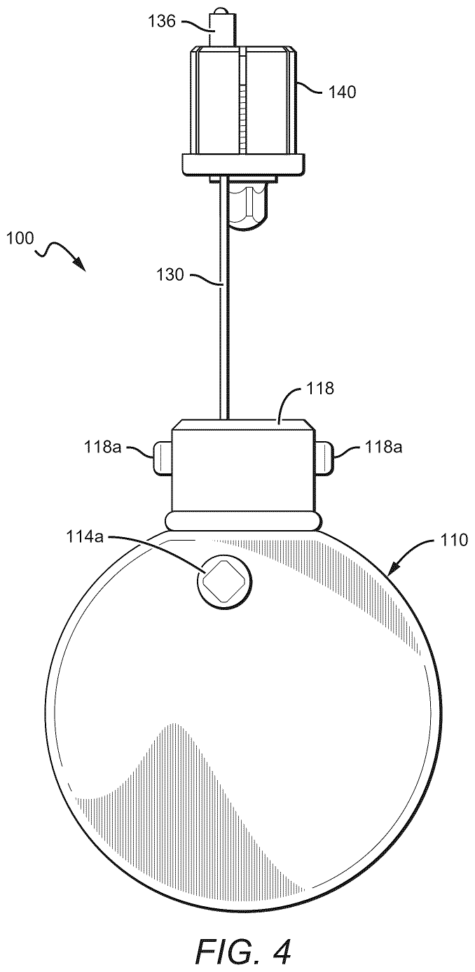

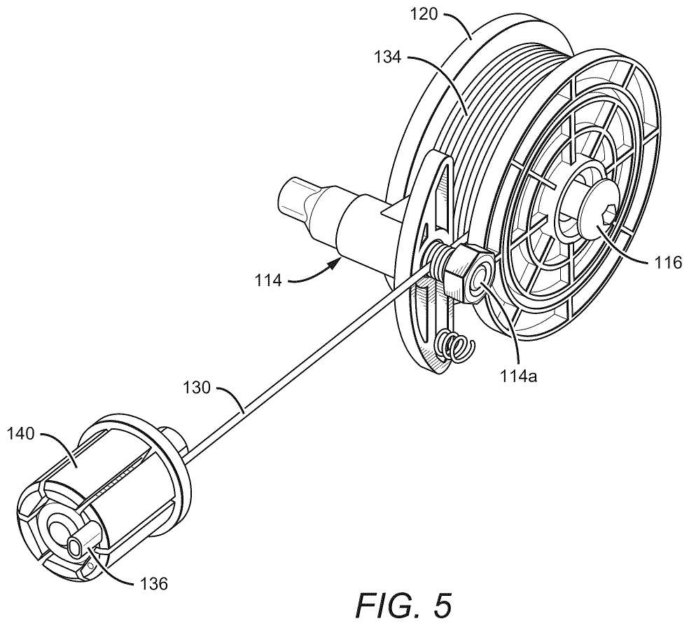

FIGS. 1 through 5 show an embodiment of a height locking device 100 for drum stands according to the present disclosure. In the specific embodiment shown, the device 100 comprises a housing 110, a retracting spool (referring to hereinafter as an automatically retracting spool, though it is understood that non-automatic embodiments are possible) 120 (see FIG. 5), a cord 130, and an attachment mechanism 140. The spool 120 is rotatably mounted inside the housing 110, such as on an axle 116, though other embodiments are possible. For example, in other embodiments, the spool 120 may not auto-retract and may have the capability of being manually retractable by a user. In some embodiments with a spool 120 that automatically retracts, the auto-retracting feature may be controlled by a wound-up spring attached to the spool 120, though it should be understood that other means are possible as would be understood by one of skill in the art. In an embodiment of a height locking device 100, the housing 110 may further comprise a stand connection piece 118 (which may be a separate component or an integral part of the housing 110) and/or a locking mechanism 114. The housing can be made of many different materials known in the art, including but not limited to plastics, composites, metals, and combinations thereof. Embodiments utilizing lighter materials such as plastics and/or composites can have the advantage of being easier to transport, while embodiments utilizing heavier materials such as metals can provide the benefit of weighting down the stand to lessen the chances of unintended movement during performance. It should be understood that fewer than all of these components, and/or additional components or multiples of the shown components, are possible. For instance and by way of example only, some embodiments do not utilize a housing.

The stand connection piece 118 and the attachment mechanism 140 can connect the height locking device 100 to a drum stand 200. In the specific embodiment shown in FIGS. 1-5, the attachment mechanism 140 is a plug that can be sized to fit within the inner diameter of a drum stand tube, such as the uppermost drum stand tube of a drum stand (though while the term “uppermost” is used herein, embodiments where an upper tube that is not literally the uppermost tube are possible). This can be accomplished using, for example, a friction fit, an elastic fit whereby one or more portions of the attachment mechanism 140 push outward against the inner diameter of the tube, or other means known in the art. Additionally, non-plug embodiments are also envisioned, either in combination with or in place of the plug functionality. For instance, connectors or fasteners such as drum screws could be used to make this connection; adhesives could be used; the cord could be tied to a component of the stand; or other connection means could be used as would be understood by one of skill in the art. The connection between the attachment mechanism 140 and the drum stand can be permanent or can be a detachable connection as shown.

The cord comprises a spool end, a body 134, and a free end 136. The spool end is connected to the spool 120 and, as best shown in FIG. 5, the body 134 is wrapped around the spool 120. The cord 130 can be passed through a locking mechanism 114 enclosed in the housing 110, as best seen in FIG. 5. Then, the free end 136 of the cord 130 can be passed through an opening 112 of the housing 110 and/or the stand connection piece 118. In the specific embodiment shown, the opening 112 is through the stand connection piece 118, and thus the cord can be directly inserted into the lower tube of a stand when the stand connection piece 118 is engaged; however, it should be understood that other embodiments are possible and many different placements of the opening than what is shown are possible.

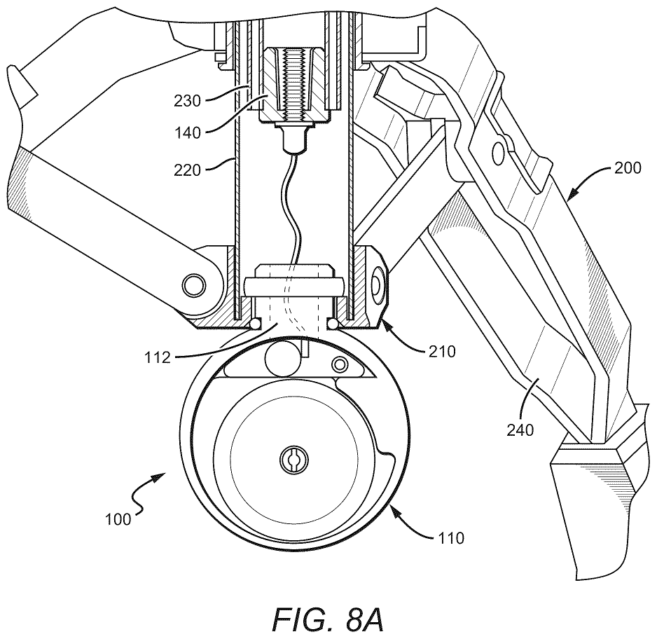

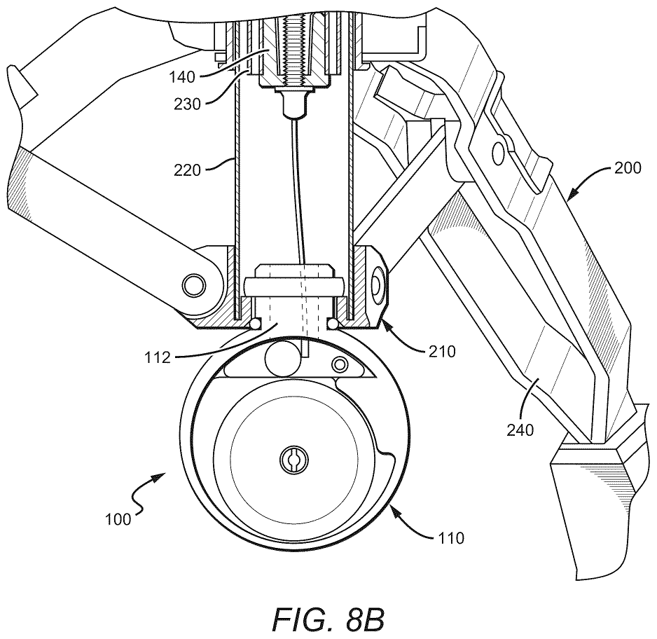

The free end 136 of the cord 130 is connected to the attachment mechanism 140 (referred to hereinafter as the “plug 140” for simplicity, though it should be understood that other attachment mechanisms are possible). The plug 140 prevents the free end 136 of the cord 130 from auto-retracting into the housing 110, and also is configured to attach (e.g., removably attach) to another section of the drum stand, such as to a drum stand tube. In one specific embodiment, the plug 140 attaches to the bottom of the uppermost tube of the drum stand, as will be discussed in more detail below with regard to FIGS. 8A and 8B.

As shown in FIGS. 1 through 5, the plug 140 may comprise a plurality of panels 142 attached at a base of the plug 140. The plug will typically be substantially circular so as to match the inner diameter of the uppermost tube, though other shapes are possible. The panels 142 can be semi-flexible and/or elastic to allow them to create a circumferential friction fit inside a drum stand tube when the plug 140 is inserted. The plug 140 may be made from plastics, composites, and other flexible and similar materials as would be understood by one of skill in the art. Many different materials, shapes, and embodiments are possible.

The stand connection piece 118 of the housing 110 is configured to connect to the base of a drum stand 200 allowing the plug 140 and the free end 136 of the cord 130 to be passed through the hollow interior of the drum stand and/or its tube(s) 220. The plug 140 is then attached to another portion of the stand, such as to one of the tubes, such as the uppermost tube 230, and such as the bottom of the uppermost tube 230 of the drum stand 200. It is understood, however, that the plug 140 may be attached to another tube, such as a lowermost tube or an intermediate tube.

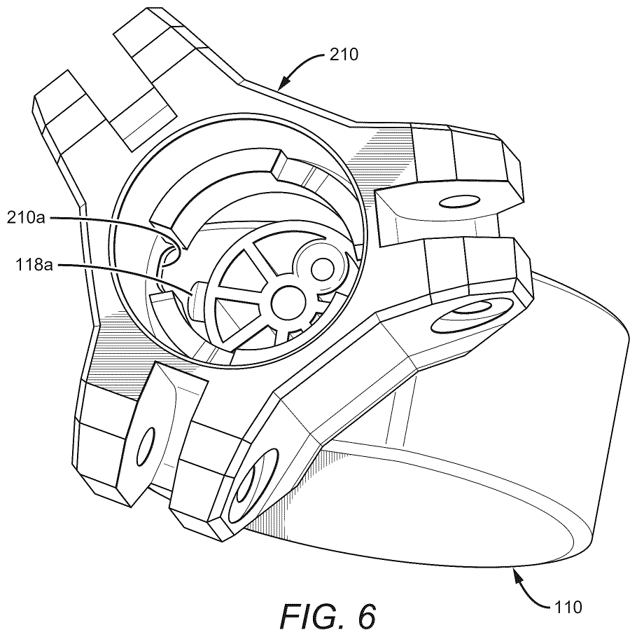

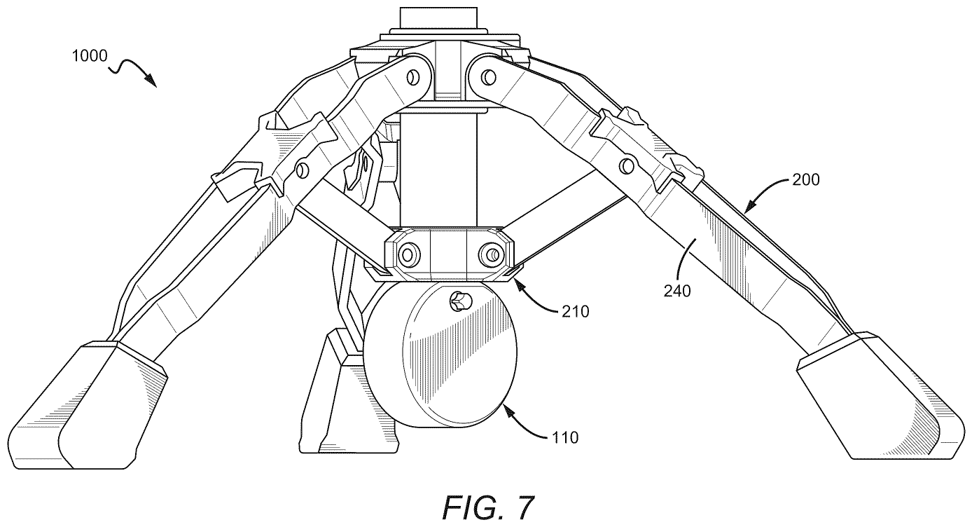

FIGS. 6-8B show an example of a base component 210 of a percussion stand's 200 base that is configured to removably mate with the stand connection piece 118 of the housing 110. The base component 210 shown is configured with one or more (e.g., two) slots 210a (e.g., L-shaped slots) and the stand connection piece 118 has one or more (e.g., two) protrusions (e.g., posts) 118a that are able to insert into the slots 210a. Once the stand connection piece 118 has been inserted into the slots 210a, the stand connection piece 118 and the housing 110 can be rotated to lock the height locking device 100 in place at the base of the stand 200. It is also possible for a separate component (e.g., a rubber component) with one or more slots similar to or the same as the slots 210 to be inserted into the stand's base 200 to serve this purpose, rather than the slots being included in the stand 200 and/or base component 210 themselves. Many different connection mechanisms (e.g. snap connection, friction fit, push button, etc.), both permanent and detachable, are possible, as would be understood by one of skill in the art. Additionally, while in the embodiment shown the base component 210 also includes attachment portions for the legs 240, other embodiments (e.g. not including leg attachment portions) are possible.

Initial attachment of the plug 140 (or alternative connection mechanism) can be achieved in a number of ways as would be understood by one of skill in the art. For instance, the uppermost tube can be removed, the stand turned upside down, and the cord 130 (locked with a long cord length) fed through the stand's tubing until the free end 136 and plug 140 emerge from the other end of the tubing. The plug 140 can then be attached to the bottom of the uppermost tube, which can then be reattached to the remainder of the tubing system.

Once the plug 140, or any alternative connection mechanism for the free end 136 of the cord 130, is attached to the uppermost tube 230 of the drum stand 200, the drum stand 200 can be adjusted to its ideal height. This should be done while the cord length is unlocked, so as to allow retraction of the cord 130 when the uppermost tube is lowered and extension of the cord 130 when the uppermost tube is raised. The user can then lock the drum stand height using known devices (e.g., one or more wing nuts), and then engage the locking mechanism 114 in order to lock in place the length of the cord 130, and thus, in effect, lock in place the overall height of the drum stand. At this point, the drum stand 200 can be collapsed and stored because the cord 130 is collapsible, but easily restored to the exact same height using the length or height at which the cord 130 was locked, because as the user extends the uppermost tube upward, the cord 130 will become taut at substantially the same cord length and drum stand height as when the user engaged the locking mechanism 114. Typically locking the drum stand height prior to locking cord length (so the retraction action is still in place when the drum stand height is locked) will Achieve the best results, though it is understood that other orders of operation (such as locking cord length before locking stand height) are possible.

The locking mechanism 114 in the embodiment shown in FIG. 5 is a clamping system 114 located in the housing 110, but other locking mechanisms are possible as would be understood by one of skill in the art. The locking mechanism 114 can include a clamp engaged by a fastener or connector 114a, such as a drum screw. The fastener/connector 114a can serve as part of the clamp or be a separate element. The fastener or connector (e.g., drum screw) 114a can be controlled by, e.g., a drum key, or by hand, or otherwise as would be understood by one of skill in the art. When engaged and/or tightened, the locking mechanism 114 inhibits and/or prevents movement of the cord 130. For instance, in this specific embodiment and as shown in FIG. 5, the locking mechanism 114 and/or fastener 114a, when tightened into a locked position, pinches the cord 130 between two components (which could include the fastener 114a itself). Thus, the portion of the cord 130 distal from the spool 120 and/or separated from the spool 130 by the locking mechanism 114 is no longer subject to the automatic retraction action of the spool. In locking the cord 130 instead of the spool 120, one avoids placing load and/or tension on the spool 120. Locking the spool 120 instead of the cord 130 may also require a strong locking mechanism as well as a strong spool support and/or break, among other things. However, it is understood that other locking mechanisms are possible in place of or in conjunction with the above mechanism, including a locking mechanism that inhibits the auto-retraction of the spool 120, such as by pinching one or more components of the spool 120; and should be understood that spool-locking embodiments are within the scope of the present disclosure.

FIG. 8A shows a height locking device 100 with its plug 140 connected to the uppermost tube 230 (e.g., the bottom of the tube) and the stand connection piece 118 connected to the bottom of the lower most tube 220, with the cord 130 locked at a specific length. The stand 200 shown in FIG. 8A is not fully adjusted to the locked length of the cord 130. FIG. 8B shows the stand 200 adjusted to the height established by the height locking device 100, still with the cord 130 locked at a specific length. The stand of FIGS. 8A and 8B (in this case a two-tube stand, though three-tube stands and even more tube stands are possible) can be broken down to the position of FIG. 8A and redeployed to the position of FIG. 8B while maintaining cord length and, thus, maintaining overall stand height upon redeployment.

A height locking device's 100 cord 130 can be flexible so it does not prevent easy collapsibility and storage of the drum stand. In a preferred embodiment, the cord 130 comprises cable, such as steel cable. However, other many other materials for the cord are possible, such as synthetic fibers (e.g., Kevlar), natural fibers, insulated cables, parachute cord (or paracord), rope (e.g., synthetic rope), string, or the like. The cord 130 can be elastic or inelastic, with inelastic versions having the benefit of having a substantially set length when pulled taut, as opposed to elastic versions which could be pulled further (and thus beyond the locked height). The cord 130 can be flexible or inflexible, with flexible materials having the benefit of better avoiding becoming stuck within the tubes upon breakdown and redeployment. The cord 130 may also be insulated and/or braided, or neither. Furthermore, the cord can be many different lengths. In some embodiments the cord is 1 foot or greater, 2 feet or greater, 3 feet or greater, 6 feet or less, 5 feet or less, 4.5 feet or less, or ranges of any of these measurements, such as between 1.5 and 4.5 feet and/or between 2 and 4 feet, though it is understood that many different cord lengths are possible, and that cord length can be adjusted based on the stand with which it is to be used. The cord can have a diameter of, for example, 0.1 mm to 10 mm, or 0.2 mm to 5 mm, or 0.5 mm to 2.5 mm, or 0.75 mm to 1.5 mm, or about 1 mm; or greater than or less than any of these measurements; though it is understood that many different cord diameters/thicknesses are possible.

It is understood that embodiments presented herein are meant to be exemplary. Although the present disclosure has been described in detail with reference to certain preferred configurations thereof both in the specification and in the claims, other versions are possible. Embodiments of the present disclosure can comprise any combination of compatible devices/features described herein and/or shown in the figures, and these embodiments should not be limited to those expressly illustrated and discussed. For instance and not by way of limitation, the appended claims could be modified to be multiple dependent claims so as to combine any combinable combination of elements within a claim set, or from differing claim sets. Claims depending on one independent claim could be modified so as to depend from a different independent claim. Therefore, the spirit and scope of the disclosure should not be limited to the versions described above.

While the foregoing written description of the disclosure enables one of ordinary skill to make and use what is considered presently to be the best mode thereof, those of ordinary skill will understand and appreciate the existence of variations, combinations, and equivalents of the specific embodiments, methods, systems, and examples herein. The disclosure should therefore not be limited by the above-described embodiments, methods, systems, and examples. Furthermore, certain terminology has been used for the purposes of descriptive clarity, and not to limit the present disclosure. It is therefore intended that the following appended claims include all such alterations, modifications and permutations as fall within the true spirit and scope of the present disclosure. No portion of the disclosure is intended, expressly or implicitly, to be dedicated to the public domain if not set forth in the claims.

We claim:

1. A height locking device for a percussion stand comprising:
a housing;
a stand connection piece connected to said housing and configured to connect said housing to a base of a percussion stand;
a retracting spool rotatably mounted inside said housing;
a cord comprising a spool end, a body, and a free end, wherein said spool end is attached to said spool, at least part of said body is coiled around said spool, and said free end is outside of said housing, wherein said free end is configured to be connected to a tube of a percussion stand; and
a locking mechanism configured to inhibit retraction of said cord when engaged.

2. The device of claim 1, wherein said cord is a steel cable.

3. The device of claim 1, wherein said stand connection piece comprises an opening, and wherein said free end of said cord passes through said opening.

4. The device of claim 1, further comprising a plug on said free end, said plug configured to be plugged into said tube.

5. The device of claim 4, wherein said plug is configured to connect to said tube via a friction fit.

6. The device of claim 1, wherein said locking mechanism comprises a clamp and a fastener configured to engage said clamp.

7. The device of claim 1, wherein said locking mechanism locks said cord when engaged.

8. The device of claim 1, wherein said locking mechanism locks movement of said spool when engaged.

9. The device of claim 1, wherein said locking mechanism comprises a screw on an outside of said housing, and wherein said locking mechanism is engageable via said screw.

10. The device of claim 1, further comprising an attachment mechanism on said free end, said attachment mechanism configured to attach to said tube.

11. The device of claim 1, wherein said stand connection piece is integral with said housing.

12. The device of claim 1, wherein said percussion stand comprises a plurality of tubes, and wherein said tube is the uppermost tube of said plurality of tubes.

13. A percussion stand system comprising:
a percussion stand comprising a plurality of tubes comprising an uppermost tube and a lowermost tube and a plurality of legs;
a height locking device comprising:
a housing;
a stand connection piece connecting said housing to said base of said percussion stand;
a retracting spool rotatably mounted inside of said housing;
a cord comprising a spool end, a body, and a free end, wherein said spool end is attached to said spool, at least part of said body is coiled around said spool, and said free end is outside of said housing, wherein said free end is connected to said percussion stand's uppermost tube; and
a locking mechanism configured to inhibit retraction of said cord when engaged.

14. The percussion stand system of claim 13, further comprising a base component attached to a bottom of said lowermost tube, wherein said base component is configured to removably connect to said stand connection piece.

15. The percussion stand system of claim 14, wherein said base component is at least partially within said bottom of said lowermost tube.

16. The percussion stand system of claim 13, wherein said stand connection piece comprises an opening, and wherein said free end of said cord passes through said opening into said lowermost tube.

17. The percussion stand system of claim 13, further comprising an attachment mechanism on said free end, said attachment mechanism configured to be connected to said uppermost tube.

18. The percussion stand system of claim 17, wherein said attachment mechanism is a plug configured to connect to said uppermost tube via a friction fit.

19. The percussion stand system of claim 13, wherein said locking mechanism comprises a clamp and a fastener configured to engage said clamp.

20. The percussion stand system of claim 19, wherein said clamp locks said cord when engaged.

21. The percussion stand system of claim 13, wherein said locking mechanism is engaged by a drum screw on an outside of said housing.

22. A method of setting the height of a percussion stand system comprising a lowermost tube, an uppermost tube connected to said lowermost tube, and a height locking device comprising a retracting spool, a cord, and a locking mechanism, wherein said height locking device is connected to said lowermost tube and a free end of said cord is connected to said uppermost tube, said method comprising:
when said locking mechanism is disengaged such that said retracting spool is acting upon said free end of said cord such that said cord is taut, extending said uppermost tube relative to said lowermost tube to a desired height; and
engaging said locking mechanism such that said retracting spool is no longer acting on said free end of said cord.
